(19) United States
(12) Patent Application Publication
(10) Pub. No.: US 2020/0211540 A1
(43) Pub. Date: Jul. 2, 2020

(54) CONTEXT-BASED SPEECH SYNTHESIS

(71) Applicant: Microsoft Technology Licensing, LLC, Redmond, WA (US)

(72) Inventors: Duncan Og MACCONNELL, Seattle, WA (US); Thomas Charles BUTCHER, Seattle, WA (US)

(21) Appl. No.: 16/233,988

(22) Filed: Dec. 27, 2018

(51) Int. Cl. G10L 15/22; G10L 13/04; G10L 15/16

(52) U.S. Cl. CPC G10L 15/22; G10L 15/16; G10L 13/043

(57) ABSTRACT

A system and method includes capture of first speech audio signals emitted by a first user, conversion of the first speech audio signals into text data, input of the text data into a trained network to generate second speech audio signals based on the text data, processing of the second speech audio signals based on a first context of a playback environment, and playback of the processed second speech audio signals in the playback environment.

### BACKGROUND

Modern computing applications may capture and playback audio of a user's speech. Such applications include videoconferencing applications, multi-player gaming applications, and audio messaging applications. The audio often suffers from poor quality both at capture and playback.

Typically, a microphone used to capture speech audio for a computing application is built-in to a user device, such as a smartphone, tablet or notebook computer. These microphones capture low-quality audio which exhibits, for example, low signal-to-noise ratios and low sampling rates. Even off-board, consumer-grade microphones provide poor quality audio when used in a typical audio-unfriendly physical environment.

High-quality speech audio, if captured, may also present problems. High-quality audio consumes more memory and requires more transmission bandwidth than low-quality audio, and therefore may negatively affect system performance or consume an unsuitable amount of resources. On playback, even high-quality audio may fail to integrate suitably with the hardware, software and physical environment in which the audio is played.

Systems are desired to efficiently provide suitable speech audio to computing applications.

### BRIEF DESCRIPTION OF THE DRAWINGS

FIG. 1 is a block diagram of a system to synthesize speech according to some embodiments;

FIG. 2 is a flow diagram of a process synthesize speech according to some embodiments;

FIG. 3 is a block diagram of a system to train a network according to some embodiments;

FIG. 4 depicts a videoconferencing system implementing speech synthesis according to some embodiments;

FIG. 5 depicts an audio/video device which may implement speech synthesis according to some embodiments;

FIG. 6 is an internal block diagram of an audio/video device which may implement speech synthesis according to some embodiments;

FIG. 7 depicts a mixed-reality scene according to some embodiments;

FIG. 8 depicts a mixed-reality scene which may incorporate speech synthesis according to some embodiments;

FIG. 9 depicts a mixed-reality scene which may incorporate speech synthesis according to some embodiments;

FIG. 10 is a block diagram of a system to synthesize speech according to some embodiments;

FIG. 11 is a block diagram of a system to synthesize speech according to some embodiments; and

FIG. 12 is a block diagram of a cloud computing system which may implement speech synthesis according to some embodiments.

### DETAILED DESCRIPTION

The following description is provided to enable any person in the art to make and use the described embodiments. Various modifications, however, will remain apparent to those in the art.

Embodiments described herein provide a technical solution to the technical problem of inefficient and poor-quality audio transmission and playback in a computing environment. According to some embodiments, clear speech audio is generated by a trained network based on input text (or speech audio) and is processed based on the context of its sending and/or receiving environment prior to playback. Some embodiments conserve bandwidth by transmitting text data between remote sending and receiving systems and converting the text data to speech audio at the receiving system.

Embodiments may generate speech audio of a quality which is not limited by the quality of the capturing microphone or environment. Processing of the generated speech audio may reflect speaker placement, room response, playback hardware and/or any other suitable context information.

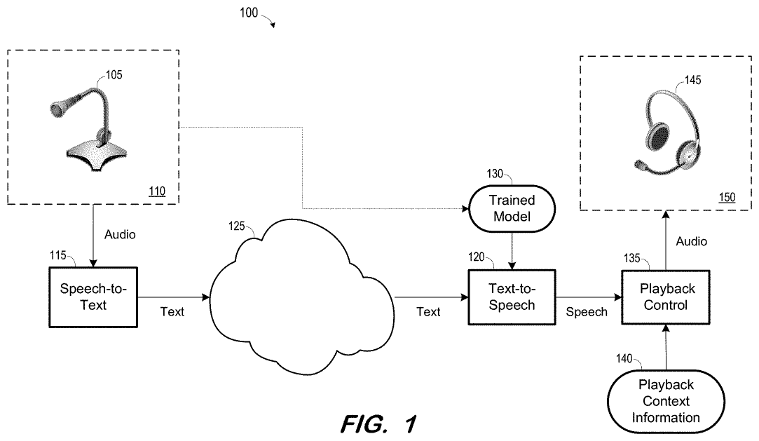

FIG. 1 illustrates system 100 according to some embodiments. System 100 may provide efficient generation of particularly-suitable speech audio at a receiving system based on speech audio input at a sending system. Generally, and according to some embodiments, input speech audio is converted to text data at a sending system and speech audio data is generated from the text data at a receiving system. The generated speech data may reflect any vocal characteristics on which the receiving system has been trained, and may be further processed to reflect the context in which it will be played back within the receiving system. This context may include an impulse response of the playback room, spatial information associated with the speaker (i.e., sending user), desired processing effects (reverb, noise reduction), and any other context information.

System 100 includes microphone 105 located within physical environment 110. Microphone 105 may comprise any system for capturing audio signals, and may be separate from or integrated with a computing system (not shown) to any degree as is known. Physical environment 110 represents the acoustic environment in which microphone 105 resides, and which affects the sonic properties of audio acquired by microphone 110. In one example, physical properties of environment 110 may generate echo which affects the speech audio captured by microphone 105.

According to the example of FIG. 1, a user speaks into microphone 105 and resulting speech audio generated by microphone 105 is provided to speech-to-text component 115. Speech-to-text component 115 outputs text data based on the received speech audio. The output text data may be considered a transcription (in whatever format it might be) of the words spoken by the user into microphone 105.

“Text data” as referred to herein may comprise ASCII data or any other type of data for representing text. The text data may comprise another form of coding, such as a language-independent stream of phoneme descriptions including pitch information, or another other binary format that isn't understandable by humans. The text data may include indications of prosody, inflection, and other vocal characteristics that convey meaning but are outside of a simple word-based format. Generally, speech-to-text component 115 may be considered to “encode” or “compress” the received audio signals to the desired text data transmission format.

Speech-to-text component 115 may comprise any system for converting audio to text that is or becomes known. Component 115 may comprise a trained neural network deployed on a computing system to which microphone 105 is coupled. In another example, component 115 may comprise a Web Service which is called by a computing system to which microphone 105 is coupled.

The text data generated by speech-to-text component 115 is provided to text-to-speech component 120 via network 125. Network 125 may comprise any combination of public and/or private networks implementing any protocols and/or transmission media, including but not limited to the Internet. According to some embodiments, text-to-speech component 120 is remote from speech-to-text component 115 and the components communicate with one another over the Internet, with or without the assistance of an intermediate Web server. The communication may include data in addition to the illustrated text data. More-specific usage examples of systems implementing some embodiments will be provided below.

Text-to-speech component 120 generates speech audio based on the received text data. The particular system used to generate the speech audio depends upon the format of the received text data. Text-to-speech component 120 may be generally considered a decoder counterpart to the encoder of speech-to-text component 115, although the intent of text-to-speech component 120 is not to reproduce the audio signals which were encoded by speech-to-text component 115.

In the illustrated example, text-to-speech component 120 may utilize trained model 130 to generate the speech audio. Trained model 130 may comprise, in some embodiments, a Deep Neural Network (DNN) such as Wavenet which has been trained to generated speech audio from input text as is known in the art.

The dotted line of FIG. 1 indicates that trained model 130 has been trained by the user in conjunction with microphone 105. For example, the user may have previously spoken suitable training phrases into microphone 105 in order to create a training set of labeled speech audio on which model 130 was trained. Trained model 130 need not be limited to training by the current user of microphone 105, but may have been trained based on any voice or system for outputting speech audio. In the latter cases, the speech audio generated by component 120 will reflect the vocal characteristics of the other voice or system.

According to some embodiments, the text data may be in a first language and be translated into a second language prior to reception by text-to-speech component 120. Text-to-speech component 120 then outputs speech audio in the second language based on trained model 130, which has preferably been trained based on speech audio and text of the second language.

Playback control component 135 processes the speech audio output by text-to-speech component 120 to reflect any desirable playback context information 140. Playback context information 140 may include reproduction characteristics of headset (i.e., loudspeaker) 145 within playback environment 150, an impulse response of playback environment 150, an impulse response of recording environment 110, spatial information associated with microphone 105 within recording environment 110 or associated with a virtual position of microphone 105 within playback environment 150, signal processing effects intended to increase perception of the particular audio signal output by component 120, and any other context information.

In some embodiments, the speech audio generated by component 120 is agnostic of acoustic environment and includes substantially no environment-related reverberations. This characteristic allows playback control 135 to apply virtual acoustics to the generated speech audio with more perceptual accuracy than otherwise. Such virtual acoustics include a virtualization of a specific room (i.e., a room model), audio equipment such as an equalizer, compressor, reverberator. The aforementioned room model may represent, for example, an “ideal” room for different contexts such as a meeting, solo work requiring concentration, and group work.

Playback context information 140 may also include virtual acoustic events to be integrated into the generated speech audio. Interactions between the generated speech audio and these virtual acoustic events can be explicitly crafted, as the generated speech audio can be engineered to interact acoustically with the virtual acoustic events (e.g., support for acoustical perceptual cues: frequency masking, doppler effect, etc.).

Some embodiments may therefore provide “clean” speech audio in real-time based on recorded audio, despite high levels of noise while recording, poor capture characteristics of a recording microphone, etc. Some embodiments also reduce the bandwidth required to transfer speech audio between applications while still providing high-quality audio to the receiving user.

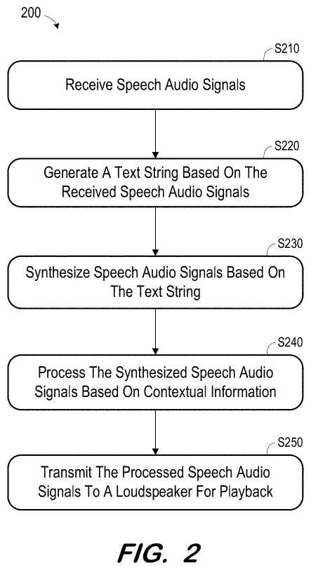

FIG. 2 is a flow diagram of process 200 according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Embodiments are not limited to the examples described below.

Initially, speech audio signals are received at S210. The speech audio signals may be captured by any system for capturing audio signals, for example microphone 105 described above. As also described above, the speech audio signals may be affected by the acoustic environment in which they are captured as well as the recording characteristics of the audio capture device. The captured speech audio signals may be received at S210 by a computing system intended to execute S220.

At S220, a text string is generated based on the received speech audio signals. S220 may utilize any speech-to-text system that is or becomes known. The generated text string may comprise any data format for representing text, including but not limited to ASCII data.

According to some embodiments, S210 and S220 are executed by a computing system operated by a first user intending to communicate with a second user via a communication application. In one example, the communication application is a Voice Over IP (VOIP) application. The communication application may comprise a videoconferencing application, a multi-player gaming application, or any other suitable application.

Next, at S230, speech audio signals are synthesized based on the text string. With respect to the above-described example of S210 and S220, the text string generated at S220 may be transmitted to the second user prior to S230. Accordingly, at S230, a computing system of the second user may operate to synthesize speech audio signals based on the text string. Embodiments are not limited thereto.

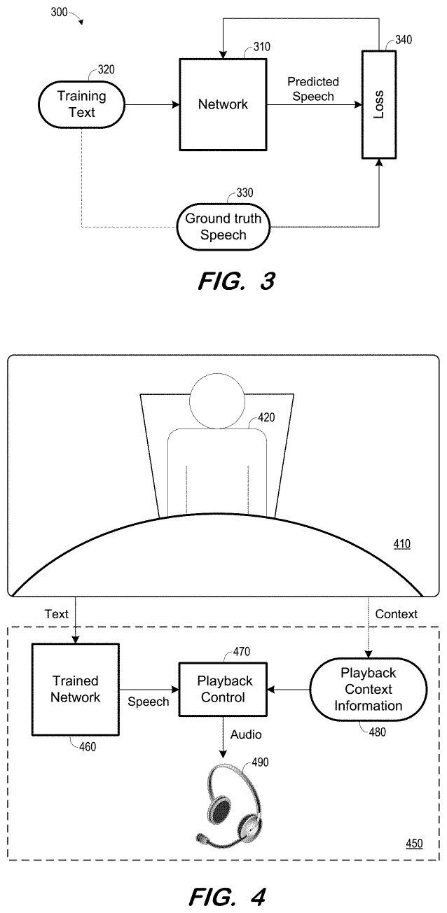

The speech audio signals may be synthesized at S230 using any system that is or becomes known. According to some embodiments, S230 utilizes a trained model 130 to synthesize speech audio signals based on the input text string. FIG. 3 illustrates system 300 to train a network for use at S230 according to some embodiments.

Network 310 is trained using training text 320, ground truth speech 330 and loss layer 340. Embodiments are not limited to the architecture of system 300. Training text 320 includes sets of text strings and ground truth speech 330 includes speech audio file associated with each set of text strings of training text 320.

Generally, and according to some embodiments, network 310 may comprise a network of neurons which receive input, change internal state according to that input, and produce output depending on the input and internal state. The output of certain neurons is connected to the input of other neurons to form a directed and weighted graph. The weights as well as the functions that compute the internal state can be modified by a training process based on ground truth data. Network 310 may comprise any one or more types of artificial neural network that are or become known, including but not limited to convolutional neural networks, recurrent neural networks, long short-term memory networks, deep reservoir computing and deep echo state networks, deep belief networks, and deep stacking networks.

During training, network 310 receives each set of text strings of training text 320 and, based on its initial configuration and design, outputs a predicted speech audio signal for each set of text strings. Loss layer component 340 determines a loss by comparing each predicted speech audio signal to the ground truth speech audio signal which corresponds to its input text string.

A total loss is determined based on all the determined losses. The total loss may comprise an L1 loss, and L2 loss, or any other suitable measure of total loss. The total loss is back-propagated from loss layer component 340 to network 310, which changes its internal weights in response thereto as is known in the art. The process repeats until it is determined that the total loss has reached an acceptable level or training otherwise terminates. At this point, the now-trained network implements a function having a text string as input and an audio signal as output.

The synthesized speech audio is processed based on contextual information at S240. As described with respect to FIG. 1, the contextual information may include reproduction characteristics of a loudspeaker within an intended playback environment, an impulse response of the playback environment, an impulse response of an environment in which the original speech audio signals were captured, an impulse response of another environment, and/or spatial information associated with signal capture or with a virtual position within the playback environment. S240 may include application of signal processing effects intended to increase perception of the particular audio signals synthesized at S230.

The processed speech audio is transmitted to a loudspeaker for playback at S250. The loudspeaker may comprise any one or more types of speaker systems that are or become known, and the processed signal may pass through any number of amplifiers or signal processors as is known in the art prior to arrival at the loudspeaker.

FIG. 4 illustrates an example of process 200 according to some embodiments. In the example, speech audio is captured in sender environment 410 from sender 420. The speech audio is converted to text data at environment 410 and transmitted to receiving environment 450. A computing system of environment 450 executes trained network 460 to synthesize speech audio signals based on the received text data. According to some embodiments, trained network 460 implements a function which was previously trained based on ground truth speech audio signals from sender 420. Embodiments are not limited thereto, as network 460 may have been trained based on speech audio signals of a different person, a computer-generated voice, or any other source of speech audio signals.

Playback control 470 is executed to process the synthesized speech audio signals based on playback context information 480. Playback context information 480 may include any context information described above, but is not limited thereto. As illustrated by a dotted line, context information for use by playback control 470 may be received from environment 410, perhaps along with the aforementioned text data. This context information may provide acoustic information associated with environment 420, position data associated with sender 420, or other information.

The processed audio may be provided to headset 490 which is worn by a receiving user (not shown). Some embodiments may include a video stream from environment 410 to environment 450 which allows the receiving user to view user 420 as shown in FIG. 4. In addition to being more clear and easily perceived than the audio signals captured in environment 410, the processed audio signals played by headset 490 may exhibit spatial localization corresponding to the apparent position of user 420 in environment 410.

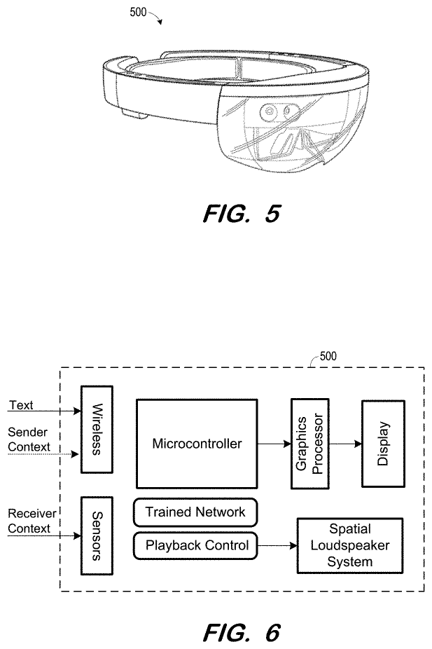

Some embodiments may be used in conjunction with mixed-, augmented-, and/or virtual-reality systems. FIG. 5 is a view of a head-mounted audio/video device which may implement speech synthesis according to some embodiments. Embodiments are not limited to device 500.

Device 500 includes a speaker system for presenting spatialized sound and a display for presenting images to a wearer thereof. The images may completely occupy the wearer's field of view, or may be presented within the wearer's field of view such that the wearer may still view other objects in her vicinity. The images may be holographic.

Device 500 may also include sensors (e.g., cameras and accelerometers) for determining the position and motion of device 500 in three-dimensional space with six degrees of freedom. Data received from the sensors may assist in determining the size, position, orientation and visibility of images displayed to a wearer.

According to some embodiments, device 500 executes S230 through S250 of process 200. FIG. 6 is an internal block diagram of some of the components of device 500 according to some embodiments. Each component may be implemented using any combination of hardware and software.

Device 500 includes a wireless networking component to receive text data at S230. The text data may be received via execution of a communication application on device 500 and/or on a computing system to which device 500 is wirelessly coupled. The text data may have been generated based on remotely-recorded speech audio signals as described in the above examples, but embodiments are not limited thereto.

Device 500 also implements a trained network for synthesizing speech audio signals based on the received text data. The trained network may comprise parameters and/or program code loaded onto device 500 prior to S230, where it may reside until the communication application terminates.

As illustrated by a dotted line and described with respect to FIG. 4, device 500 may also receive context information associated with a sender's context. The sensors of device 500 also receive data which represents the context of device 500. The sensors may detect room acoustics and the position of objects within the room, as well as the position of device 500 within the room. The playback control component of device 500 may utilize this context information as described above to process the audio signals synthesized by the trained network. The processed audio signals are then provided to the spatial loudspeaker system of device 500 for playback and perception by the wearer.

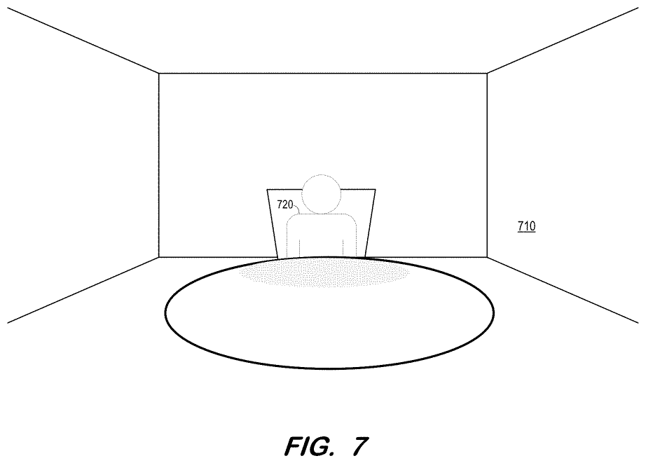

As shown in FIG. 6, device 500 may also include a graphics processor to assist in presenting images on its display. Such images may comprise mixed-reality images as depicted in FIGS. 7 through 9.

The example of FIG. 7 is seen from the perspective of a wearer of device 500. The wearer is located in environment 710 and every object shown in FIG. 7 is also located in environment 710 (i.e., the wearer sees the “real” object), except for user 720. The image of user 720 may be acquired by a camera of a remote system and provided to device 500 via a communication application (e.g., a videoconferencing application). As is known in the art, device 500 operates to insert an image of user 720 into the scene viewed by the wearer.

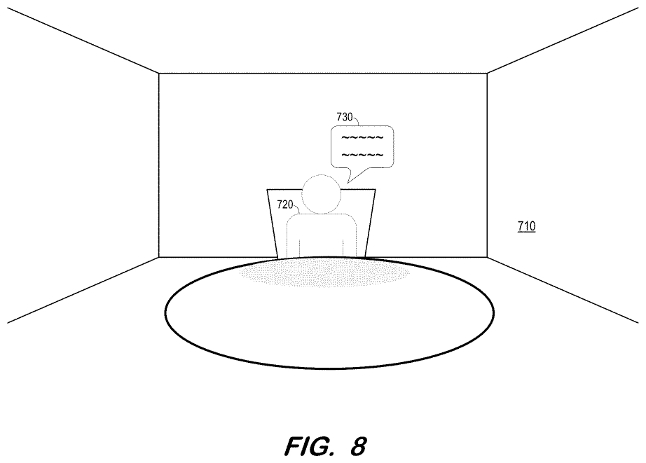

According to some embodiments, device 500 may also receive text data generated from speech audio of user 720 as described above. Device 500 may then execute S230 through S250 to synthesize speech audio signals based on the text data, process the synthesized speech audio signals based on contextual information (e.g., the sender context and the receiver context of FIG. 6), and transmit the processed signals to its speaker system for playback. FIG. 8 depicts such playback, in which speech bubble 730 depicts the playback of processed speech audio signals such that they seem to be originating from the position of user 720. Bubble 730 is not actually displayed according to some embodiments.

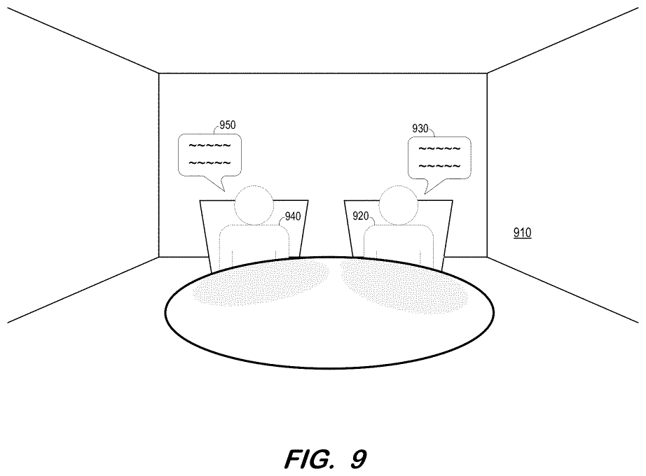

FIG. 9 depict a similar scene in which device 500 receives text data of two remote users 920 and 940, who may also be remote from one another. Context information of each remote user may also be received, as well as context information associated with environment 910. Each of users 920 and 940 may be associated with a respective trained network, which is used to synthesize speech audio signals based on the text data of its respective user.

Context information of user 920 and of environment 910 may then be used to process speech audio signals synthesized by the trained network associated with user 920. Similarly, context information of user 940 and of environment 910 may be used to process speech audio signals synthesized by the trained network associated with user 940. As shown by speech bubbles 930 and 950, device 500 may play back the processed audio signals within a same user session of environment 910 such that they appear to the wearer to emanate from user 920 and user 940, respectively. It should be noted that devices operated by one or both of users 920 and 940 may similarly receive text data from device 500 and execute S230 through S250 to play back corresponding processed speech audio signals as described herein.

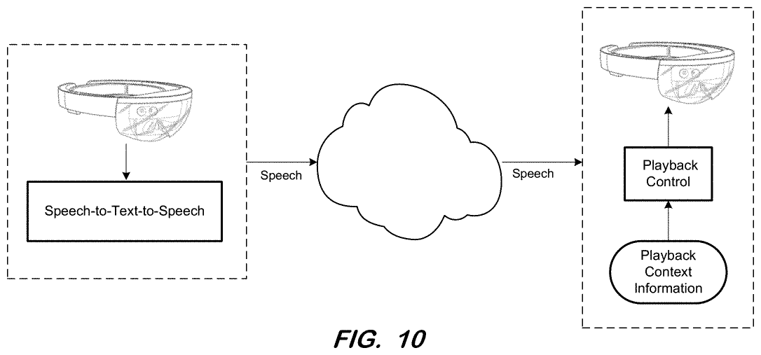

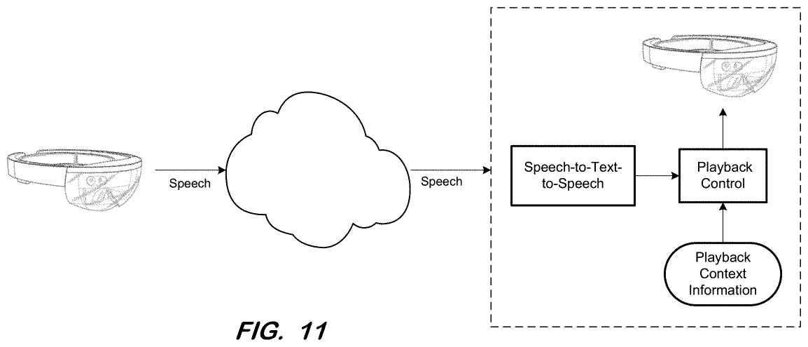

FIGS. 10 and 11 illustrate embodiments in which a single component executes S210 through S230 of process 200, either on the sender side (FIG. 10) or the receiver side (FIG. 11). In particular, the component, which may include one or more neural networks, receives recorded speech audio signals, generates a text string based on the signals, and synthesizes speech audio signals based on the text string. The component may be implemented on the recording device (e.g., FIG. 10) or on the playback device (FIG. 11).

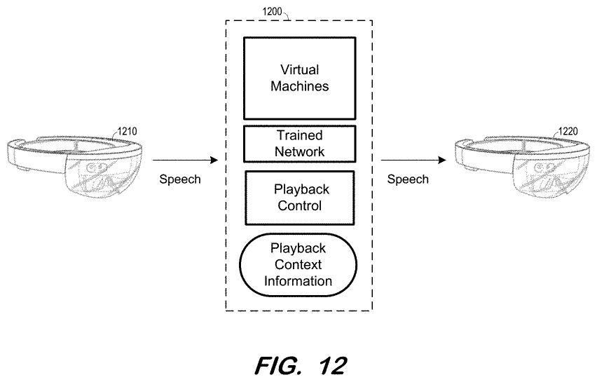

FIG. 12 illustrates cloud-based system 1200 according to some embodiments. System 1200 may include any number of virtual machines, virtual servers and cloud storage instances. System 1200 may execute an application providing speech synthesis and processing according to some embodiments.

Device 1210 may communicate with the application executed by system 1200 to provide recorded speech signals thereto, intended for a user of device 1220. As described above, system 1200 receives the speech audio signals, generates a text string based on the signals, and synthesizes speech audio signals based on the text string. System 1200 may process the signals using context information and provide the processed signals to device 1220 for playback. Device 1220 may further process the received speech signals prior to playback, for example based on context information local to device 1220.

System 1200 may support bi-directional communication between devices 1210 and 1220, and any other one or more computing systems. Each device/system may process and playback received speech signals as desired.

Each functional component described herein may be implemented at least in part in computer hardware, in program code and/or in one or more computing systems executing such program code as is known in the art. Such a computing system may include one or more processing units which execute processor-executable program code stored in a memory system.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Those in the art will appreciate that various adaptations and modifications of the above-described embodiments can be configured without departing from the claims. Therefore, it is to be understood that the claims may be practiced other than as specifically described herein.

What is claimed is:

1. A computing system comprising:
a first computing device comprising one or more processing units to execute processor-executable program code to cause the first computing device to:
receive text data;
generate first audio signals based on the text data, the first audio signals representing speech;
determine a first context of a playback environment; and
process the first audio signals based on the first context; and
a speaker system to playback the processed first audio signals in the playback environment.

2. A computing system according to claim 1, further comprising:
a second computing device comprising one or more second processing units to execute second processor-executable program code to cause the second computing system to:
receive input audio signals, the input audio signals representing speech;
generate the text data based on the received input audio signals; and
transmit the text data to the first computing device.

3. A computing system according to claim 2, the second processor-executable program code to cause the second computing system to:
determine a second context of a recording environment of the input audio signals; and
transmit the second context to the first computing device,
wherein the first audio signals are processed based on the first context and the second context.

4. A computing system according to claim 3, wherein the second context comprises a spatial location of a first user in the recording environment, and wherein the first context comprises a spatial location of a second user in the playback environment.

5. A computing system according to claim 4, wherein the first context comprises acoustic characteristics of the playback environment.

6. A computing system according to claim 2, further comprising:
a third computing device comprising one or more third processing units to execute third processor-executable program code to cause the third computing system to:
receive second input audio signals, the second input audio signals representing second speech;
generate second text data based on the received second input audio signals; and
transmit the second text data to the first computing device,
the first computing device comprising one or more processing units to further execute processor-executable program code to cause the first computing device to:
receive the second text data;
generate third audio signals based on the second text data, the third audio signals representing speech; and
process the third audio signals based on the first context, and
the speaker system to playback the processed first audio signals and the processed third audio signals in the playback environment.

7. A computing system according to claim 1, wherein the first context comprises acoustic characteristics of the playback environment.

8. A computer-implemented method comprising:
capturing first speech audio signals emitted by a first user;
converting the first speech audio signals into text data;
inputting the text data into a trained network to generate second speech audio signals based on the text data;
processing the second speech audio signals based on a first context of a playback environment; and
playing the processed second speech audio signals in the playback environment.

9. A computer-implemented method according to claim 8, further comprising:
determining a second context of a recording environment in which the first speech audio signals were captured,
wherein processing the second speech audio signals comprises:
processing the second speech audio signals based on the first context and the second context.

10. A computer-implemented method according to claim 9, wherein the second context comprises a spatial location of the first user in the recording environment, and wherein the first context comprises a spatial location of a second user in the playback environment.

11. A computer-implemented method according to claim 10, wherein the first context comprises acoustic characteristics of the playback environment.

12. A computer-implemented method according to claim 8, wherein the first context comprises acoustic characteristics of the playback environment.

13. A computer-implemented method according to claim 8, further comprising:
capturing third speech audio signals emitted by a second user;
converting the third speech audio signals into second text data;
inputting the second text data into a second trained network to generate fourth speech audio signals based on the second text data;
processing the fourth speech audio signals based on the first context of the playback environment; and
playing the processed fourth speech audio signals in the playback environment.

14. A computer-implemented method according to claim 13, wherein the second processed speech audio signals and the fourth speech audio signals are played in a same user session of the playback environment.

15. A computing system to:
receive first speech audio signals emitted by a first user;
convert the first speech audio signals into text data;
generate second speech audio signals based on the text data;
process the second speech audio signals based on a first context of a playback environment; and
transmit the processed second speech audio signals to the playback environment.

16. A computing system according to claim 15, the computing system further to:
determine a second context of a recording environment of the first speech audio signals,
wherein processing of the second speech audio signals comprises:
processing of the second speech audio signals based on the first context and the second context.

17. A computing system according to claim 16, wherein the second context comprises a spatial location of the first user in the recording environment, and wherein the first context comprises a spatial location of a second user in the playback environment.

18. A computer-implemented method according to claim 17, wherein the first context comprises acoustic characteristics of the playback environment.

19. A computing system according to claim 15, wherein generation of the second speech audio signals comprises input of the text data to a network trained based on training speech audio signals emitted by the first user.

20. A computing system according to claim 15, the computing system further to:
receive third speech audio signals emitted by a second user;
convert the third speech audio signals into second text data;
generate fourth speech audio signals based on the second text data;
process the fourth speech audio signals based on the first context of the playback environment; and
transmit the processed fourth speech audio signals to the playback environment.
